(19) United States
(12) Patent Application Publication
(10) Pub. No.: US 2012/0259019 A1
(43) Pub. Date: Oct. 11, 2012

(54) COMPOSITION AND APPLICATION PROCESS FOR LIQUID ANTIFUNGAL

(76) Inventor: Maria Silva Martins de Souza, Sao Paulo-SP (BR)

(21) Appl. No.: 13/515,749

(22) PCT Filed: Feb. 1, 2010
(86) PCT No.: PCT/BR2010/000036

§ 371 Date: Jun. 13, 2012

(51) Int. Cl. A01N 31/02; A01P 3/00

(52) U.S. Cl. 514/724

(57) ABSTRACT

Embodiments of the present invention relate to a non-aqueous antifungal composition that comprises an alcoholic solvent, a preservative, a wetting agent and a flavoring agent, which can be used in the bakery industry when applied on the surface of products by spraying. Embodiments of the present invention result in food products having result reduced contamination by fungi and increased shelf life, without adversely affecting the product's flavor profile, texture and appearance.

The invention relates to a composition used in bakery industry for increasing shelf life.

This composition, also known as antifungal or mold inhibitor, is intended to reduce the incidence of mold on bakery and pastry products, such as breads, cakes, pizza dough, panettones, etc.

The products in the bakery industry are usually susceptible of mold contamination, which is the most frequent determining factor for the end of their shelf life. Among microorganisms usually affecting breads and pastry products, there are: Aspergillus sp, Cladosporium sp, and Penicillum sp.

Obtaining a longer shelf life means great cost reduction for manufacturers, however, that must be done in such a way as not to harm consumers' health. A longer shelf life may be obtained by using antifungals formulated with inputs considered GRAS (Generally Recognized As Safe) by the FDA (US Food and Drug Administration).

There are currently several antifungals used in the bakery industry, most of which are included in the dough, before fermentation. As the yeasts performing the fermentation are also sensitive to antifungals, the possibility of their use is limited, being at risk of fermentation getting impaired. It would then be interesting to apply the antifungal after the fermentation. Obtaining actives within fat microcapsules to incorporate in the dough is intended to reach this goal. As the melting point of the fat encapsulating the active is higher than 60° C., the capsule opening occurs in the oven, preventing fermentation-performing yeasts from being affected by the active. It is a technically interesting proposal, however, it is costly, as the technology to obtain the capsules is not easy to perform.

Other references, such as US2007/0264398A1, are about products preventing the growth of bacteria such as Salmonella, Staphylococus, Listeria and others, however, bacterial contamination is not frequent in bakery products, but the mold is. Additionally, it is more difficult for antifungals incorporated in the dough to avoid fungi growth on breads surface, which occurs more often than internal mold appears. Thus, it is interesting to obtain a product with antifungal action that can be applied on breads and pastry products surface, without changing their flavor and using safe raw material for the consumer. Patent US2007/0031543 proposes an edible coating with antifungal protection. The product uses acidulated calcium sulfate and has multiple layers, but its preparation and application is highly costly. In addition to these documents, there are in the market antifungal products with the same function as this invention, applied by spraying on breads surfaces, however, they are composed only of water and potassium sorbate. Such solution, usually prepared by the bread manufacturers themselves, does not provide a significant increase in the shelf life. U.S. Pat. No. 4,208,443 dated 1980, is about an antifungal comprising a preservative alcoholic solution with use indicated for grains, such as corn and others. Said market or inventive products have a composition and indications for use and/or application means different from this invention, and consequently, different action and results.

The antifungal in the present invention is liquid, to be applied on bakery products surface. It comprises food grade products and does not change food flavor or appearance. Application is made by spraying the surface, either with a manual sprayer, aerosol, or with a machine as EPA—Automatic Spraying Belt, manufactured and marketed by NAMP Indústria e Comércio de Revestimento e Máquinas Ltda. Containing nozzles in several positions and making the product form a very thin mist; the machine mentioned allows covering the whole breads surface.

### PRODUCT DESCRIPTION

The antifungal object of the application does not have an aqueous base, and has the following composition, in their proportions:
alcoholic solvent—20 to 90%
preservative—0.001 to 18.0%
wetting agent—0.5 to 60%
flavor—0.001 to 2.5%

The preservatives that may be used include: sorbic acid and its salts, propionic acid and its salts, parabens as methylparaben, ethylparaben, propylparaben and butylparaben, benzoic acid and its salts, or a combination thereof.

As wetting agent, a glycol or a polyol may be used, such as maltitol, mannitol, sorbitol, xylitol or a combination thereof. To mask unpleasant flavors of some components, a flavor is used.

The manufacturing process comprises weighing the alcoholic solvent and put it in a stainless steel container provided with a shaker. Preservative dissolution follows, under thorough shaking and light heating, if needed. After complete dissolution the wetting agent is added. Shaking follows until it is completely homogenized. At last flavor is added.

As it does not contain water as the other products in the market, the antifungal in this invention does not leave remainders over breads surface, so the food does not get a wet appearance, and neither, concerning regular breads, slicing gets difficult.

The antifungal object of this invention was especially developed to make precision applications possible by means of spray, aerosols, application guns, as well as modular pulverization systems, which make automatic pulverization guns performance easier, by pulverizing the surface desired in a uniform and precise way. As an example of product application, a rate of 100 g/minute may be accomplished, on 400-g breads, with 1 to 3 g per bread. Working conditions would be: average discharge of 0.4 gallons/minute at 2.75 BAR, with spraying made by 6 8XP05 nozzles and 1 orange 110X1 nozzle.

When compared to existing products in the market, the present invention has a cost-effective characteristic, as its manufacturing process is not complex. It acts even when 1 to 4 g are applied over a 500-g bread, thanks to its concentration and viscosity. As it is possible to automate the application, less time and employees are spent to perform this operation. Increased shelf life provided may reach 100% or more, when compared to a baked product without the addition of preservatives.

After application, a thin and invisible layer forms on products surface, protecting them and increasing their durability, thereby reducing losses and increasing profitability for manufacturers of breads, cakes, pies and the like.

Every component in the product has its use authorized in the food industry, and does not cause harm to consumer's health, neither interferes with the flavor, appearance and texture of the final product.

1-10. (canceled)

11. A non-aqueous antifungal composition, comprising: an alcoholic solvent, a preservative, a wetting agent and a flavoring agent.

12. The non-aqueous antifungal composition of claim 11, wherein the percentage of the alcoholic solvent in the composition ranges from 20% to 90%.

13. The non-aqueous antifungal composition of claim 11, wherein the percentage of the preservative in the composition ranges from 0.001% to 18.0%.

14. The non-aqueous antifungal composition of claim 11, wherein the percentage of the wetting agent in the composition ranges from 0.5% to 60%.

15. The non-aqueous antifungal composition of claim 11, wherein the percentage of the flavoring agent in the composition ranges from 0.001 to 2.5%.

16. The non-aqueous antifungal composition of claim 11, wherein the preservative is propanoic acid or a salt thereof, parabens, sorbic acid or a salt thereof, benzoic acid or a salt thereof, or any combination thereof.

17. The non-aqueous antifungal composition of claim 11, wherein the wetting agent is a polyol, or a glycol.

18. The non-aqueous antifungal composition of claim 17, wherein the polyol is manitol, xylitol, maltitol, sorbitol, or a combination thereof.

19. The non-aqueous antifungal composition of claim 11, wherein the glycol is food grade glycol.

20. The non-aqueous antifungal composition of claim 11, wherein the flavoring agent is food grade.

21. The non-aqueous antifungal composition of claim 11, wherein the antifungal is a clear liquid that can be applied by spraying, and wherein the antifungal provides an increase of 100% or more in the product shelf life when compared to another sample manufactured without the use of preservatives.

22. A method of ameliorating contamination of food products, comprising:
providing a non-aqueous antifungal composition, comprising: an alcoholic solvent, a preservative, a wetting agent and a flavoring agent;
applying an effective antifungal amount of the liquid antifungal composition in the form of a mist of droplets to the food product.
